(19) United States
(12) Patent Application Publication
(10) Pub. No.: US 2016/0283711 A1
(43) Pub. Date: Sep. 29, 2016

(54) eMMC Monitoring Method and Apparatus

(71) Applicant: Huawei Device Co., Ltd., Shenzhen (CN)

(72) Inventors: Zhigang Li, Shenzhen (CN); Feng Han, Beijing (CN)

(21) Appl. No.: 15/172,407

(22) Filed: Jun. 3, 2016

Related U.S. Application Data
(63) Continuation of application No. PCT/CN2014/092943, filed on Dec. 3, 2014.

(30) Foreign Application Priority Data
Dec. 4, 2013 (CN) 201310648750.5

(51) Int. Cl. G06F 21/44; G06F 3/06

(52) U.S. Cl. CPC G06F 21/44; G06F 3/0622; G06F 3/0653; G06F 3/0679

(57) ABSTRACT

Embodiments of the present disclosure disclose an Embedded Multi Media Card (eMMC) monitoring method and apparatus. The monitoring method includes monitoring an amount of data that is read and written on an eMMC when the amount of data that is read and written on the eMMC reaches a preset first upper limit value, collecting statistics on an amount of data that is read and written on the eMMC by each currently running application program on the eMMC, performing authentication on an application program whose amount of data that is read and written exceeds a second upper limit value, and processing, according to an authentication result, the application program whose amount of data that is read and written exceeds the second upper limit value. According to the embodiments of the present disclosure, a use status of an eMMC can be accurately obtained, thereby ensuring a service life of the eMMC.

### CROSS REFERENCE TO RELATED APPLICATIONS

This application is a continuation of International Application No. PCT/CN2014/092943, filed on Dec. 3, 2014, which claims priority to Chinese Patent Application No. 201310648750.5, filed on Dec. 4, 2013, both of which are hereby incorporated by reference in their entireties.

### TECHNICAL FIELD

The present disclosure relates to the field of computer technologies, and in particular, to an Embedded Multi Media Card (eMMC) monitoring method and apparatus.

### BACKGROUND

Generally, an erase and write life of an eMMC is limited to some extent, and the life mainly depends on a quantity of erase and write times. When the quantity of erase and write times reaches a limit, the whole eMMC becomes read-only. After the eMMC becomes read-only, a mobile phone configured with the eMMC cannot start and cannot be recovered. Therefore, determining an erase and write life of an eMMC according to a quantity of erase and write times has become a problem concerned by mobile phone manufactures.

To determine a quantity of erase and write times, a use status of an eMMC in a mobile phone needs to be learned, and the following two implementation solutions may be used:

A first implementation solution is as follows: A manufacturer simulates a use habit of a mobile phone user before delivery of a mobile phone in order to establish a use model that is enabled for 24 hours. A read and write log (Log) of an eMMC within 24 hours is collected using the use model, and then the Log is sent back to the eMMC manufacturer for simulation. In this way, the eMMC manufacturer obtains a use status of the eMMC according to a specific simulation result, and further gives information about a service life of the eMMC.

However, research shows that, in this implementation solution, because eMMC data is statically collected once, if a user installs some programs, the simulation process becomes meaningless.

A second implementation solution is as follows: Before a mobile phone is launched on the market, a user mobile phone on which an acceptance test (such as a Beta test) is performed is retrieved in advance in order to check a use status of an eMMC to estimate a service life of the eMMC inside the mobile phone.

However, in this implementation solution, problems such as low retrieval efficiency, poor estimation precision, and a relatively great difference in use of different users still exist.

It can be seen that, in the prior art, a technology for monitoring a use status of an eMMC generally has a disadvantage of poor accuracy. When the use status of the eMMC cannot be accurately obtained, a quantity of erase and write times of the eMMC cannot be controlled, and therefore, a service life of the eMMC cannot be ensured.

### SUMMARY

Embodiments of the present disclosure provide an eMMC monitoring method and apparatus such that a use status of an eMMC can be accurately obtained, thereby ensuring a service life of the eMMC.

To resolve the foregoing technical problem, the embodiments of the present disclosure disclose the following technical solutions:

According to a first aspect, an eMMC monitoring method is provided, where the method includes monitoring an amount of data that is read and written on an eMMC, when the amount of data that is read and written on the eMMC reaches a preset first upper limit value, collecting statistics on an amount of data that is read and written on the eMMC by each currently running application program on the eMMC, performing authentication on an application program whose amount of data that is read and written exceeds a second upper limit value, and processing, according to an authentication result, the application program whose amount of data that is read and written exceeds the second upper limit value.

With reference to the first aspect, in a first possible implementation manner, the monitoring an amount of data that is read and written on an eMMC includes monitoring, according to a preset time interval, a total amount of data that is read and written on the eMMC in a preset time range.

With reference to the first aspect or the first possible implementation manner, in a second possible implementation manner, the collecting statistics on an amount of data that is read and written on the eMMC by each currently running application program on the eMMC includes acquiring a currently running process, determining, according to execution file information corresponding to the process, an application program that executes the process, and collecting statistics on an amount of data that is read and written on the eMMC by each application program that executes the process.

With reference to the first aspect, the first possible implementation manner, and the second possible implementation manner, in a third possible implementation manner, the performing authentication on an application program whose amount of data that is read and written exceeds a second upper limit value includes determining whether the application program whose amount of data that is read and written exceeds the second upper limit value is an application program in a preset authenticated-application-program list, and if the application program whose amount of data that is read and written exceeds the second upper limit value is an application program in the preset authenticated-application-program list, determining that the application program whose amount of data that is read and written exceeds the second upper limit value is an authenticated safe program, or if the application program whose amount of data that is read and written exceeds the second upper limit value is not an application program in the preset authenticated-application-program list, determining that the application program whose amount of data that is read and written exceeds the second upper limit value is an abnormal application program.

With reference to the first aspect and the third possible implementation manner, in a fourth possible implementation manner, the processing, according to an authentication result, the application program whose amount of data that is read and written exceeds the second upper limit value includes when the application program whose amount of data that is read and written exceeds the second upper limit value is an authenticated safe program, maintaining running of the application program whose amount of data that is read and written exceeds the second upper limit value, or when the application program whose amount of data that is read and written exceeds the second upper limit value is an abnormal application program, deleting the abnormal application program or prompting a user to delete the abnormal application program.

With reference to the first aspect and the first to the fourth possible implementation manners, in a fifth possible implementation manner, before the performing authentication on an application program whose amount of data that is read and written exceeds a second upper limit value, the method further includes updating the authenticated-application-program list by adding a customized safe program by the user, or acquiring an updated application program using a network, and updating a corresponding application program in the authenticated-application-program list using the updated application program.

According to a second aspect, an eMMC monitoring apparatus is provided, where the apparatus includes a monitoring module configured to monitor an amount of data that is read and written on an eMMC, a statistics collecting module configured to when the amount of data that is read and written on the eMMC reaches a preset first upper limit value, collect statistics on an amount of data that is read and written on the eMMC by each currently running application program on the eMMC, an authenticating module configured to perform authentication on an application program whose amount of data that is read and written exceeds a second upper limit value, and a program processing module configured to process, according to an authentication result, the application program whose amount of data that is read and written exceeds the second upper limit value.

With reference to the second aspect, in a first possible implementation manner, the monitoring module includes a time presetting unit configured to preset a time interval, and an amount monitoring unit configured to monitor, according to the time interval, a total amount of data that is read and written on the eMMC in a preset time range.

With reference to the second aspect and the first possible implementation manner, in a second possible implementation manner, the statistics collecting module includes a process acquiring unit configured to acquire a currently running process, a program determining unit configured to determine, according to execution file information corresponding to the process, an application program that executes the process, and a data amount statistics collecting unit, configured to collect statistics on an amount of data that is read and written on the eMMC by each application program that executes the process.

With reference to the second aspect, the first possible implementation manner, and the second possible implementation manner, in a third possible implementation manner, the authenticating module includes a judgment unit configured to determine whether the application program whose amount of data that is read and written exceeds the second upper limit value is an application program in a preset authenticated-application-program list, and a result determining unit configured to if the application program whose amount of data that is read and written exceeds the second upper limit value is an application program in the preset authenticated-application-program list, determine that the application program whose amount of data that is read and written exceeds the second upper limit value is an authenticated safe program, or if the application program whose amount of data that is read and written exceeds the second upper limit value is not an application program in the preset authenticated-application-program list, determine that the application program whose amount of data that is read and written exceeds the second upper limit value is an abnormal application program.

With reference to the second aspect and the third possible implementation manner, in a fourth possible implementation manner, the program processing module includes a first processing unit configured to when the application program whose amount of data that is read and written exceeds the second upper limit value is an authenticated safe program, maintain running of the application program whose amount of data that is read and written exceeds the second upper limit value, or a second processing unit configured to when the application program whose amount of data that is read and written exceeds the second upper limit value is an abnormal application program, delete the abnormal application program or prompt a user to delete the abnormal application program.

With reference to the second aspect and the first to the fourth possible implementation manners, in a fifth possible implementation manner, the apparatus further includes a list updating unit configured to update the authenticated-application-program list by adding a customized safe program by a user, or acquire an updated application program using a network, and update a corresponding application program in the authenticated-application-program list using the updated application program.

In the embodiments of the present disclosure, monitoring is performed on a use status of an in-use eMMC, that is an amount of data that is read and written on the eMMC is monitored, when the amount of data that is read and written on the eMMC reaches a preset first upper limit value, statistics are collected on an amount of data that is read and written on the eMMC by each currently running application program on the eMMC, and an application program whose amount of data that is read and written exceeds a second upper limit value is determined, and authentication is performed on the application programs whose amount of data that is read and written exceeds the second upper limit value in order to obtain a specific authentication result, and then corresponding processing is performed, according to the authentication result, on the application programs whose amount of data that is read and written exceeds the second upper limit value. It can be seen that, according to the eMMC monitoring method, a use status of an eMMC can be accurately obtained, and a read and write access operation on the eMMC can be controlled according to the use status of the eMMC, thereby ensuring a service life of the eMMC.

### BRIEF DESCRIPTION OF DRAWINGS

To describe the technical solutions in the embodiments of the present disclosure or in the prior art more clearly, the following briefly introduces the accompanying drawings required for describing the embodiments. Apparently, a person of ordinary skill in the art may still derive other drawings from these accompanying drawings without creative efforts.

FIG. 1 is a schematic flowchart of an eMMC monitoring method according to an embodiment of the present disclosure,

FIG. 2 is a schematic flowchart of specific implementation of step 102 shown in FIG. 1,

FIG. 3 is a schematic flowchart of specific implementation of step 103 shown in FIG. 1,

FIG. 4 is a schematic structural diagram of an eMMC monitoring apparatus according to an embodiment of the present disclosure,

FIG. 5 is a schematic structural diagram of specific implementation of a statistics collecting module shown in FIG. 4,

FIG. 6 is a schematic structural diagram of specific implementation of an authenticating module shown in FIG. 4,

FIG. 7 is a schematic structural diagram of specific implementation of a program processing module shown in FIG. 4,

FIG. 8 is a schematic structural diagram of another eMMC monitoring apparatus according to an embodiment of the present disclosure,

FIG. 9 is a schematic diagram of a specific application scenario according to the present disclosure, and

FIG. 10 is a schematic structural diagram of a terminal that implements eMMC monitoring based on a computer system according to an embodiment of the present disclosure.

### DESCRIPTION OF EMBODIMENTS

To make a person skilled in the art understand the technical solutions in the embodiments of the present disclosure better, and make the objectives, features, and advantages of the embodiments of the present disclosure clearer, the following describes the technical solutions in the embodiments of the present disclosure in further detail with reference to the accompanying drawings.

First, an eMMC monitoring method provided in the present disclosure is introduced.

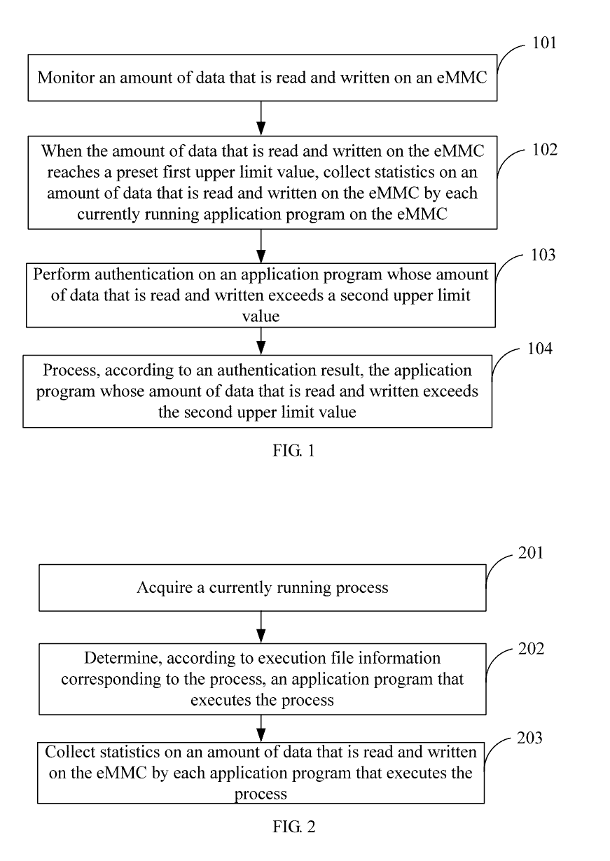

FIG. 1 is a schematic flowchart of an eMMC monitoring method according to an embodiment of the present disclosure, and a processing process may include the following steps:

Step 101: Monitor an amount of data that is read and written on an eMMC.

In this step, monitoring and statistics collection on the amount of data that is read and written on the eMMC are implemented.

A service life of the eMMC depends on an amount of written data. While a read operation on the eMMC does not affect the life of the eMMC, too frequent read operations may deteriorate system performance. Therefore, collecting statistics on an amount of read data corresponding to a read operation may provide a reference for optimizing the system performance.

Therefore, in this embodiment of the present disclosure, an amount of data that is collected for statistics and monitored is a total amount of read and written data, which includes an amount of data that is read from the eMMC and an amount of data that is written into the eMMC during each operation on the eMMC.

Step 102: When the amount of data that is read and written on the eMMC reaches a preset first upper limit value, collect statistics on an amount of data that is read and written on the eMMC by each currently running application program on the eMMC.

In this embodiment of the present disclosure, the first upper limit value of the amount of data that is read and written on the eMMC may be preset according to an empirical value, and maybe used as an upper limit value of an amount of data that is accessed on the eMMC. When it is detected that the amount of data that is read and written on the eMMC reaches the preset first upper limit value, it is preliminarily determined that an abnormal access situation occurs, and an application program that is currently performing a read and write access operation on the eMMC needs to be determined. Statistics are further collected on an amount of data that is read and written on the eMMC by each currently running application program on the eMMC to preliminarily determine an application program with abnormal access.

In a specific implementation process, a person skilled in the art may set different first upper limit values for the eMMC according to different application scenarios. A specific value corresponding to the first upper limit value is not limited in this embodiment of the present disclosure.

Step 103: Perform authentication on an application program whose amount of data that is read and written exceeds a second upper limit value.

In this embodiment of the present disclosure, for an application program that accesses the eMMC, an upper limit value, that is, the second upper limit value, of an amount that is of read and written data and is corresponding to the program is set. By setting the second upper limit value the application program is prevented from accessing an amount of data above the upper limit value.

In this step, an application program whose amount of data that is read and written on the eMMC exceeds the second upper limit value is acquired according to a statistics collection result of a current amount of data that is read and written on the eMMC by each application program. The application program may be an abnormal application program, and therefore, authentication needs to be performed on the application program.

The authentication described herein may include determining whether an application program whose current amount of data that is read and written exceeds the second upper limit value is an authenticated safe program or an abnormal application program.

Step 104: Process, according to an authentication result, the application program whose amount of data that is read and written exceeds the second upper limit value.

In this step, after the authentication operation is performed, it may be determined whether the application program whose amount of data that is read and written exceeds the second upper limit value is an abnormal application program. Then, corresponding processing may be performed on the application program whose amount of data that is read and written exceeds the second upper limit value.

In this embodiment of the present disclosure, monitoring is performed on a use status of an in-use eMMC, that is, an amount of data that is read and written on the eMMC is monitored. When the amount of data that is read and written on the eMMC reaches a preset first upper limit value, statistics are collected on an amount of data that is read and written on the eMMC by each currently running application program on the eMMC, an application program whose amount of data that is read and written exceeds a second upper limit value is determined, authentication is performed on the application programs whose amount of data that is read and written exceeds the second upper limit value to obtain a specific authentication result, and then corresponding processing is performed, according to the authentication result, on the application programs whose amount of data that is read and written exceeds the second upper limit value. It can be seen that, according to the eMMC monitoring method, a use status of an eMMC can be accurately obtained, and a read and write access operation on the eMMC can be controlled according to the use status of the eMMC, thereby ensuring a service life of the eMMC.

For ease of understanding the technical solution of the present disclosure, the following describes the foregoing technical solution in detail in a specific implementation manner.

In this embodiment of the present disclosure, an implementation manner for monitoring the amount of data that is read and written on the eMMC may be monitoring, according to a preset time interval, a total amount of data that is read and written on the eMMC in a preset time range. For example, the preset time interval is 12 hours, and the preset time range is 72 hours, that is, a total amount of data that is read and written on the eMMC in recent 72 hours is queried every 12 hours.

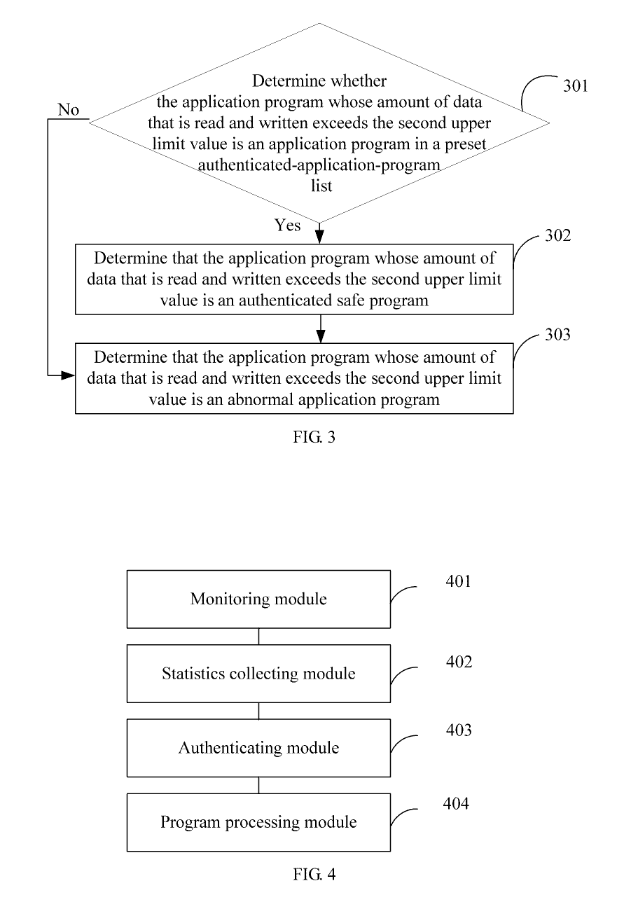

According to the preset first upper limit value of the amount of data that is read and written on the eMMC, when it is detected that an amount of data that is read and written on the eMMC reaches the preset first upper limit value, it is preliminarily determined that an abnormal access situation occurs, an application program that is currently performing a read and write access operation on the eMMC needs to be determined, and statistics are further collected on an amount of data that is read and written on the eMMC by each currently running application program. A specific process is shown in FIG. 2, which includes the following steps:

Step 201: Acquire a currently running process.

Step 202: Determine, according to execution file information corresponding to the process, an application program that executes the process.

Step 203: Collect statistics on an amount of data that is read and written on the eMMC by each application program that executes the process.

In the foregoing operation process, a currently running application program generates data that is read and written on the eMMC. Therefore, a currently running application program on the eMMC needs to be monitored. Each currently running process may be acquired according to a process identification (ID). Because corresponding execution file information exists in information about each process, which application program is accessing the eMMC may be determined using the execution file information, and then an amount of data of a read and write access operation performed on the eMMC by each application program may be acquired.

An application program whose amount of data that is read and written on the eMMC exceeds the second upper limit value is acquired according to a statistics collection result of a current amount of data that is read and written on the eMMC by each application program. The application program may be an abnormal application program, and therefore, authentication needs to be performed on the application program. A specific authentication process is shown in FIG. 3, which includes the following steps:

Step 301: Determine whether the application program whose amount of data that is read and written exceeds the second upper limit value is an application program in a preset authenticated-application-program list, and if the application program whose amount of data that is read and written exceeds the second upper limit value is an application program in the preset authenticated-application-program list, continue with step 302, or if the application program that reads and writes the data whose amount exceeds the second upper limit value is not an application program in the preset authenticated-application-program list, continue with step 303.

Step 302: Determine that the application program whose amount of data that is read and written exceeds the second upper limit value is an authenticated safe program.

Step 303: Determine that the application program whose amount of data that is read and written exceeds the second upper limit value is an abnormal application program.

In this implementation manner, an authenticated-application-program list is set in advance, and application programs in this list are authenticated by a mobile phone manufacturer. The application program whose amount of data that is read and written exceeds the second upper limit value is compared with the authenticated application programs in this list, and if the application program whose amount of data that is read and written exceeds the second upper limit value is an application program in the list, the application program to be authenticated is an authenticated safe program, or if the application program whose amount of data that is read and written exceeds the second upper limit value is not an application program in the list, the application program to be authenticated is an abnormal application program.

When an authentication result shows that the application program whose amount of data that is read and written exceeds the second upper limit value is not an application program in the list, in order to avoid a misjudgment on the abnormal application program, an alerting prompt may be sent to a user, and the user determines whether the current application program to be authenticated is an abnormal application program. This is because, in an actual application, may be found by means of authentication that the application program whose amount of data that is read and written exceeds the second upper limit value is not an application program in the list, but the application program is not an abnormal application program actually, and the application program is just not recorded in the authenticated-application-program list. Therefore, the alerting prompt is sent to the user, and the user further determines reliability of the application program, thereby improving accuracy of determining an abnormal application program.

In a specific implementation process of this embodiment of the present disclosure, the authenticated-application-program list may be updated by adding a customized safe program by a user, or an updated application program may be acquired using a network, and a corresponding application program in the authenticated-application-program list may be updated using the updated application program. By updating the application program list, accuracy of determining an abnormal application program is further improved.

After the authentication operation is performed, it may be determined whether the application program whose amount of data that is read and written exceeds the second upper limit value is an abnormal application program. Then, corresponding processing is performed, according to the authentication result, on the application program whose amount of data that is read and written exceeds the second upper limit value, which includes the following: When the application program whose amount of data that is read and written exceeds the second upper limit value is an authenticated safe program, the application program whose amount of data that is read and written exceeds the second upper limit value is added to the authenticated-application-program list, or when the application program whose amount of data that is read and written exceeds the second upper limit value is an abnormal application program, the abnormal application program is deleted.

It may be set that an operation of deleting an abnormal application program is automatically implemented by a system, that is, the abnormal application program is automatically deleted, to prevent an application program from being deleted by mistake, an alerting prompt may further be sent to a user before the abnormal application program is deleted, and the user determines whether to delete the current abnormal application program or when to delete the current abnormal application program, which may be set according to a specific application scenario, and is not limited in the present disclosure.

Corresponding to the foregoing eMMC monitoring method embodiments, the present disclosure further provides an eMMC monitoring apparatus. As shown in FIG. 4, FIG. 4 is a schematic structural diagram of an eMMC monitoring apparatus according to an embodiment, where the apparatus includes: a monitoring module 401, a statistics collecting module 402, an authenticating module 403, and a program processing module 404.

The monitoring module 401 is configured to monitor an amount of data that is read and written on an eMMC, where an amount of data that is collected for statistics and monitored is a total amount of data, which includes an amount of data that is read from the eMMC and an amount of data that is written into the eMMC during each operation on the eMMC.

A first upper limit value of the amount of data that is read and written on the eMMC may be preset according to an empirical value, and is used as an upper limit value of an amount of data that is accessed on the eMMC. When it is detected that the amount of data that is read and written on the eMMC reaches the preset first upper limit value, it is preliminarily determined that an abnormal access situation occurs, and an application program that is currently performing a read and write access operation on the eMMC needs to be determined, and statistics are further collected on an amount of data that is read and written on the eMMC by each currently running application program on the eMMC in order to preliminarily determine an application program with abnormal access.

The statistics collecting module 402 is configured to when the amount of data that is read and written on the eMMC reaches the preset first upper limit value, collect statistics on an amount of data that is read and written on the eMMC by each currently running application program on the eMMC.

The authenticating module 403 is configured to perform authentication on an application program whose amount of data that is read and written exceeds a second upper limit value.

For an application program that accesses the eMMC, an upper limit value, that is, the second upper limit value, of an amount that is of read and written data and is corresponding to the program is set. By setting the second upper limit value, a high amount of data that is accessed by the application program is prevented.

The program processing module 404 is configured to process, according to an authentication result, the application program whose amount of data that is read and written exceeds the second upper limit value.

After an authentication operation is performed, it may be determined that the application program whose amount of data that is read and written exceeds the second upper limit value is an authenticated safe program or an abnormal application program. Then, corresponding processing is performed, according to the authentication result, on the application program whose amount of data that is read and written exceeds the second upper limit value.

In this apparatus embodiment, monitoring is performed on a use status of an in-use eMMC using a monitoring module, that is, an amount of data that is read and written on the eMMC is monitored, when the amount of data that is read and written on the eMMC reaches a preset first upper limit value, statistics are collected on an amount of data that is read and written on the eMMC by each currently running application program on the eMMC, and an application program whose amount of data that is read and written exceeds a second upper limit value is determined, and authentication is performed on the application programs whose amount of data that is read and written exceeds the second upper limit value in order to obtain a specific authentication result, and then corresponding processing is performed, according to the authentication result, on the application programs whose amount of data that is read and written exceeds the second upper limit value. It can be seen that, according to the eMMC monitoring apparatus, a use status of an eMMC can be accurately obtained, and a read and write access operation on the eMMC can be controlled according to the use status of the eMMC, thereby ensuring a service life of the eMMC.

In specific implementation, the monitoring module includes a time presetting unit configured to preset a time interval, and an amount monitoring unit configured to monitor, according to the time interval, a total amount of data that is read and written on the eMMC in a preset time range.

In this way, the monitoring module implements monitoring, according to the preset time interval, the total amount of data that is read and written on the eMMC in the preset time range.

In an embodiment shown in FIG. 5, the statistics collecting module 402 may include a process acquiring unit 501 configured to acquire a currently running process, a program determining unit 502 configured to determine, according to execution file information corresponding to the process, an application program that executes the process, and a data amount statistics collecting unit 503 configured to collect statistics on an amount of data that is read and written on the eMMC by each application program that executes the process.

In this embodiment, each currently running process may be acquired according to a process ID. Because corresponding execution file information exists in information about each process, which application program is accessing the eMMC may be determined using the execution file information, and then an amount of data of a read and write access operation performed on the eMMC by each application program may be acquired.

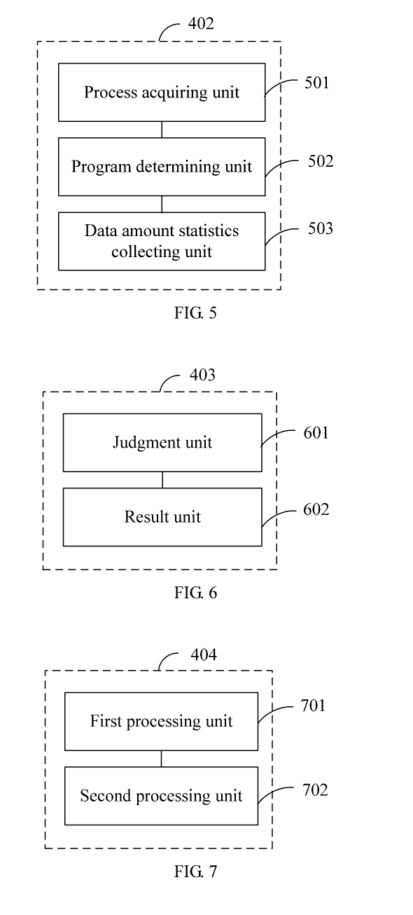

In an embodiment shown in FIG. 6, the authenticating module 403 may include a judgment unit 601 configured to determine whether the application program whose amount of data that is read and written exceeds the second upper limit value is an application program in a preset authenticated-application-program list, and a result determining unit 602 configured to if the application program whose amount of data that is read and written exceeds the second upper limit value is an application program in the preset authenticated-application-program list, determine that the application program whose amount of data that is read and written exceeds the second upper limit value is an authenticated safe program, or if the application program whose amount of data that is read and written exceeds the second upper limit value is not an application program in the preset authenticated-application-program list, determine that the application program whose amount of data that is read and written exceeds the second upper limit value is an abnormal application program.

In an implementation manner of the authenticating module, an authenticated-application-program list is set in advance, and application programs in this list are authenticated by a mobile phone manufacturer. The application program whose amount of data that is read and written exceeds the second upper limit value is compared with the authenticated application programs in this list, and if the application program whose amount of data that is read and written exceeds the second upper limit value is an application program in the list, the application program to be authenticated is an authenticated safe program, or if the application program whose amount of data that is read and written exceeds the second upper limit value is not an application program in the list, the application program to be authenticated is an abnormal application program.

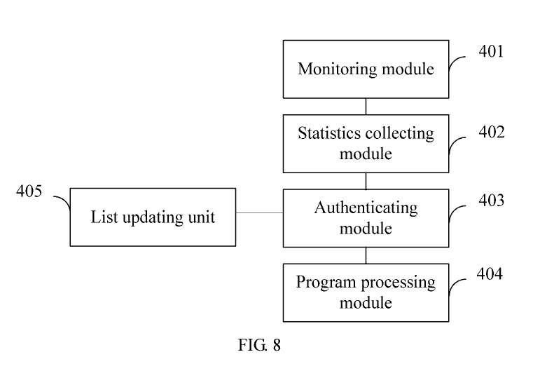

In an embodiment shown in FIG. 7, the program processing module 404 may include a first processing unit 701 configured to when the application program whose amount of data that is read and written exceeds the second upper limit value is an authenticated safe program, maintain running of the application program whose amount of data that is read and written exceeds the second upper limit value, and a second processing unit 702 configured to when the application program whose amount of data that is read and written exceeds the second upper limit value is an abnormal application program, delete the abnormal application program.

In a processing manner of the program processing module, after the authentication operation is performed, it may be determined whether the application program whose amount of data that is read and written exceeds the second upper limit value is an abnormal application program. Then, the foregoing corresponding processing is performed, according to an authentication result, on the application program whose amount of data that is read and written exceeds the second upper limit value.

In an embodiment shown in FIG. 8, the foregoing eMMC monitoring apparatus may further include a list updating unit 405 configured to update the authenticated-application-program list by adding a customized safe program by a user, or acquire an updated application program using a network, and update a corresponding application program in the authenticated-application-program list using the updated application program.

By updating the application program list, accuracy of determining an abnormal application program is further improved.

The following describes the technical solutions of the present disclosure in detail using a specific application scenario.

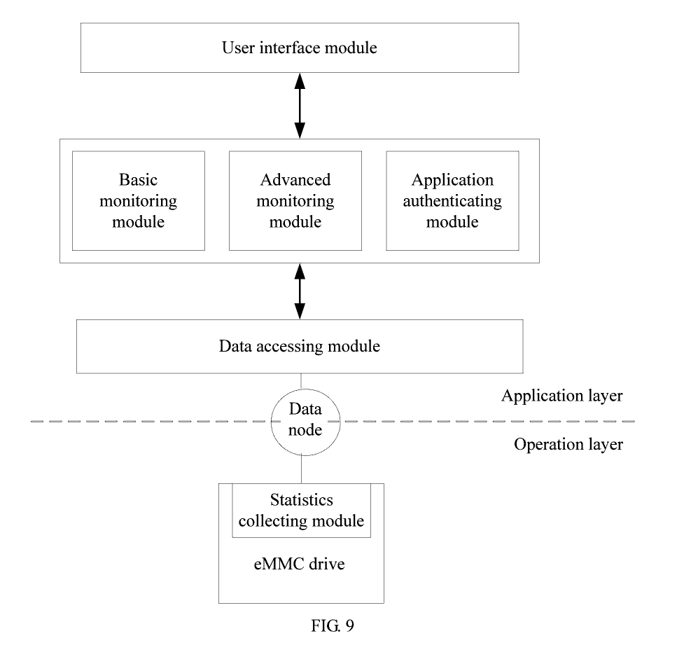

FIG. 9 is a schematic diagram of the application scenario. In this application scenario, interaction is performed between an operation layer and an application layer in a mobile phone operating system in order to implement monitoring on an eMMC.

The operation layer includes an eMMC drive, where a statistics collecting module is disposed in the eMMC drive, and the application layer includes a data accessing module, a basic monitoring module, an advanced monitoring module, an application authenticating module, and a user interface module. The following describes a function of each module.

The statistics collecting module is configured to complete statistics collection on an amount of data that is read and written on the eMMC.

A data node is a data exchange medium between the operation layer and the application layer, and the operation layer updates the amount, obtained by means of statistics collection, of data that is read and written on the eMMC to this data node.

The data accessing module completes access to the data node and provides, to an upper layer application layer, an interface for accessing the data node.

The basic monitoring module completes monitoring on a total amount of data that is read and written on the eMMC. For example, the basic monitoring module runs once every 12 hours, and queries an amount of data that is read and written on the eMMC in recent 72 hours, and if the amount of data that is read and written on the eMMC in recent 72 hours exceeds a preset upper limit value of an amount of read and written data, the advanced monitoring module is started.

The advanced monitoring module is an interface that is in a Block Layer and is for reading and writing on the eMMC, which is not started in normal times, and is started only when the basic monitoring module monitors an exception. This module learns a running process by means of a process ID, and because corresponding execution file information exists in information about each process, which application program is currently accessing the eMMC may be determined using the execution file information. Further, a data amount of a read and write operation of each process is monitored in order to acquire an amount of data of a read and write access operation performed on the eMMC by each application program.

The application authenticating module is responsible for maintaining a list that includes authenticated application programs, and the application programs in this list are authenticated by a mobile phone manufacturer. In addition, the list may further include a customized reliable program added by a user, and the list may further be updated by acquiring from a network. This module performs authentication on an application program whose amount of data that is read and written is high.

The user interface module provides a corresponding user interface according to a current monitoring status. Generally, when the basic monitoring module monitors that there is abnormal access on the eMMC, an authentication result is provided for a user using the user interface module, to prompt the user to perform a corresponding operation for the abnormal access.

In a specific application, when function division is performed on a processor inside a mobile phone according to a corresponding implementation function, the foregoing modules may be obtained, that is, the foregoing modules are software implementation manners of corresponding functions when the corresponding functions run on the processors.

In this application scenario, statistics on read and write operations performed on the eMMC are collected at a bottom layer of a drive. Analytic processing is performed, at an intermediate layer, on statistical data of read and write performed on the eMMC, when an abnormal amount of read and write access to the eMMC is monitored, a mechanism for monitoring a running application program is enabled, and the running application program is authenticated using the application authenticating module. After the authentication is performed, an application program that performs abnormal access to the eMMC may be monitored finally, and after the abnormal application program is monitored, a user may be prompted to delete the abnormal application program.

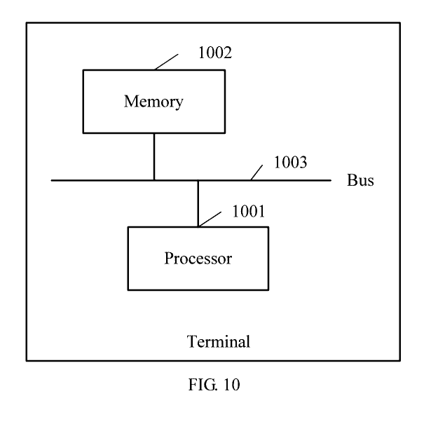

As shown in FIG. 10, the present disclosure further provides a terminal that implements eMMC monitoring based on a computer system. In specific implementation, the terminal in this embodiment of the present disclosure may include a processor 1001, a memory 1002, and a bus 1003, where the processor 1001 and the memory 1002 are interconnected using the bus 1003, the memory 1002 is configured to store a computer execution instruction, and the processor 1001 executes the computer execution instruction stored in the memory 1002 so as to execute the following operations monitoring an amount of data that is read and written on an embedded multimedia card eMMC, when the amount of data that is read and written on the eMMC reaches a preset first upper limit value, collecting statistics on an amount of data that is read and written on the eMMC by each currently running application program on the eMMC, performing authentication on an application program whose amount of data that is read and written exceeds a second upper limit value, and processing, according to an authentication result, the application program whose amount of data that is read and written exceeds the second upper limit value.

In specific implementation, the processor may preset a time interval, and monitor, according to the time interval, a total amount of data that is read and written on the eMMC in a preset time range.

A specific implementation manner for collecting, by the processor, statistics on the amount of data that is read and written on the eMMC by each currently running application program may be as follows:

The processor acquires a currently running process, determines, according to execution file information corresponding to the process, an application program that executes the process, and then collects statistics on an amount of data that is read and written on the eMMC by each application program that executes the process.

A specific implementation manner for performing, by the processor, authentication on the application program whose amount of data that is read and written exceeds the second upper limit value may include determining, by the processor, whether the application program whose amount of data that is read and written exceeds the second upper limit value is an application program in a preset authenticated-application-program list, and if the application program whose amount of data that is read and written exceeds the second upper limit value is an application program in the preset authenticated-application-program list, determining that the application program whose amount of data that is read and written exceeds the second upper limit value is an authenticated safe program, or if the application program whose amount of data that is read and written exceeds the second upper limit value is not an application program in the preset authenticated-application-program list, determining that the application program whose amount of data that is read and written exceeds the second upper limit value is an abnormal application program.

When the application program whose amount of data that is read and written exceeds the second upper limit value is an authenticated safe program, the processor may maintain running of the application program whose amount of data that is read and written exceeds the second upper limit value, or when the application program whose amount of data that is read and written exceeds the second upper limit value is an abnormal application program, the processor may delete the abnormal application program or prompt a user to delete the abnormal application program.

In addition, the processor may further update the authenticated-application-program list by adding a customized safe program by the user, or acquire an updated application program using a network, and update a corresponding application program in the authenticated-application-program list using the updated application program.

In this embodiment of the present disclosure, the processor may be a central processing unit (CPU), an application-specific integrated circuit (ASIC), or the like.

A computer storage medium can store a program, and when the program is executed, a part or all of steps in each embodiment of the eMMC monitoring method provided in the embodiments of the present disclosure may be performed. The storage medium may be a magnetic disk, an optical disc, a read-only memory (ROM), a random access memory (RAM), or the like.

A person of ordinary skill in the art may be aware that, in combination with the examples described in the embodiments disclosed in this specification, units and algorithm steps can be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that such implementation goes beyond the scope of the present disclosure.

It may be clearly understood by a person skilled in the art that, for the purpose of convenient and brief description, for a detailed working process of the foregoing system, device, and unit, reference may be made to a corresponding process in the foregoing method embodiments, and details are not described herein again.

In the several embodiments provided in the present application, it should be understood that the disclosed system, device, and method may be implemented in other manners. For example, the described device embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the devices or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present disclosure may be integrated into one processing unit, or each of the units may exist alone physically, or two or more units are integrated into one unit.

When the functions are implemented in a form of a software functional unit and sold or used as an independent product, the functions may be stored in a computer-readable storage medium. Based on such an understanding, the technical solutions of the present disclosure essentially, or the part contributing to the prior art, or a part of the technical solutions may be implemented in a form of a software product. The software product is stored in a storage medium and includes several instructions for instructing a computer device (which may be a personal computer, a server, or a network device) or a processor to perform all or a part of the steps of the methods described in the embodiments of the present disclosure. The foregoing storage medium includes any medium that can store program code, such as a universal serial bus (USB) flash drive, a removable hard disk, a ROM, a RAM, a magnetic disk, or an optical disc.

The foregoing descriptions are merely specific implementation manners of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. An embedded multimedia card (eMMC) monitoring method, comprising:
monitoring an amount of data that is read and written on an eMMC;
collecting statistics on an application-specific amount of data that is read and written on the eMMC by each currently running application program on the eMMC when the amount of data that is read and written on the eMMC reaches a preset first upper limit value;
performing authentication on an application program, wherein the application-specific amount of data that is read and written by the application program on the eMMC exceeds a second upper limit value; and
processing, according to an authentication result, the application program.

2. The method according to claim 1, wherein the monitoring an amount of data that is read and written on the eMMC comprises monitoring, according to a preset time interval, a total amount of data that is read and written on the eMMC in a preset time range.

3. The method according to claim 1, wherein collecting statistics on the application-specific amount of data that is read and written on the eMMC by each currently running application program on the eMMC comprises:
acquiring a currently running process;
determining, according to execution file information corresponding to the process, the application program that executes the process; and
collecting statistics on the application-specific amount of data that is read and written on the eMMC by each application program that executes the process.

4. The method according to claim 2, the collecting statistics on the application-specific amount of data that is read and written on the eMMC by each currently running application program on the eMMC comprises:
acquiring a currently running process;
determining, according to execution file information corresponding to the process, at least one application program that executes the process; and
collecting statistics on the application-specific amount of data that is read and written on the eMMC by each application program that executes the process.

5. The method according to claim 1, wherein performing authentication on the application program comprises:
determining whether the application program is in a preset authenticated-application-program list; and
determining that the application program is an authenticated safe program when the application program is in a preset authenticated-application-program list.

6. The method according to claim 5, wherein the processing, according to an authentication result, the application program comprises maintaining running of the application program that exceeds the second upper limit value when the application program is an authenticated safe program.

7. The method according to claim 1, wherein performing authentication on the application program comprises:
determining whether the application program is in a preset authenticated-application-program list; and
determining that the application program is an abnormal application program when the application program is not in a preset authenticated-application-program list.

8. The method according to claim 7, wherein the processing, according to an authentication result, the application program comprises:
maintaining running of the application program that exceeds the second upper limit value when the application program is an abnormal application program; and
deleting the abnormal application program.

9. The method according to claim 8, further comprising prompting a user to delete the abnormal application program.

10. The method according to claim 1, wherein before the performing authentication on the application program, the method further comprises:
updating an authenticated-application-program list by adding a customized safe program by the user or by acquiring an updated application program using a network; and
updating a corresponding application program in the authenticated-application-program list using the updated application program.

11. An eMMC monitoring apparatus, comprising:
a processor configured to:
monitor an amount of data that is read and written on an eMMC,
collect statistics on an application-specific amount of data that is read and written on the eMMC by each currently running application program on the eMMC when the amount of data that is read and written on the eMMC reaches a preset first upper limit value;
perform authentication on an application program, wherein the application-specific amount of data is read and written by the application program on the eMMC exceeds a second upper limit value; and
process, according to an authentication result, the application program.

12. The apparatus according to claim 11, wherein the processor is further configured to:
preset a time interval; and
monitor, according to the time interval, a total amount of data that is read and written on the eMMC in the time interval.

13. The apparatus according to claim 11, wherein the processor is further configured to:
acquire a currently running process;
determine, according to execution file information corresponding to the process, the application program that executes the process; and
collect statistics on the application-specific amount of data that is read and written on the eMMC by each application program that executes the process.

14. The apparatus according to claim 12, wherein the processor is further configured to:
acquire a currently running process;
determine, according to execution file information corresponding to the process, the application program that executes the process; and
collect statistics on the application-specific amount of data that is read and written on the eMMC by each application program that executes the process.

15. The apparatus according to claim 11, wherein the processor is further configured to:
determine whether the application program that exceeds the second upper limit value is in a preset authenticated-application-program list; and
determine that the application program that exceeds the second upper limit value is an authenticated safe program when the application program is in the preset authenticated-application-program list.

16. The apparatus according to claim 15, wherein the processor is further configured to maintain running of the application program when the application program is an authenticated safe program,.

17. The apparatus according to claim 11, wherein the processor is further configured to:
determine whether the application program that exceeds the second upper limit value is in a preset authenticated-application-program list; and
determine that the application program that exceeds the second upper limit value is an abnormal application program when the application program is not in the preset authenticated-application-program list.

18. The apparatus according to claim 17, wherein the processor is further configured to delete the abnormal application program when the application program is an abnormal application program.

19. The apparatus according to claim 17, wherein the processor is further configured to prompt a user to delete the abnormal application program when the application program is an abnormal application program.

20. The apparatus according to claim 11, wherein the processor is further configured to:
update an authenticated-application-program list by adding a customized safe program by the user or by acquiring an updated application program using a network; and
update a corresponding application program in the authenticated-application-program list using the updated application program.
